(19) United States
(12) Patent Application Publication
(10) Pub. No.: US 2010/0298147 A1
(43) Pub. Date: Nov. 25, 2010

(54) CONCENTRATED FORMULATIONS OF CIPC IN A DIALKYLENE GLYCOL AND USES THEREOF FOR THE ANTI-GERMINATING TREATMENT OF BULBS OR TUBERS

(76) Inventor: Alberto Sardo, Chateaurenard (FR)

Correspondence Address: STITES & HARBISON PLLC, 1199 NORTH FAIRFAX STREET, SUITE 900, ALEXANDRIA, VA, 22314, US

(21) Appl. No.: 12/780,225

(22) Filed: May 14, 2010

(30) Foreign Application Priority Data
May 19, 2009 (FR) 0953336

(51) Int. Cl. A01N 37/44

(52) U.S. Cl. 504/315

(57) ABSTRACT

The present invention relates to concentrated formulations of CIPC in a dialkylene glycol for the anti-germinating treatment of bulbs or tubers. This use is particularly appropriate for the treatment of potato tubers.

The present invention relates to concentrated formulations of CIPC in a dialkylene glycol for the anti-germinating treatment of bulbs and tubers. This use is particularly appropriate for the treatment of potato tubers.

After potatoes or other tubers are harvested, they are kept at temperatures of approximately 20 to 30° C. for approximately ten days to harden the peridermic layer (or “skin”) thereof, then progressively cooled to the storage temperature thereof, which is approximately 10° C.

For the first and second months after harvesting, the tubers remain in a dormant state and have little tendency to germinate.

However, before this period is over the tubers must be chemically treated, to inhibit germination which would lead to undesirable effects such as reduction in weight, transformation of starch into sugar, and reduction in the quality of the tubers along with deterioration in their appearance. Moreover, sprouts and the surrounding tissues contain high levels of toxic glycoalkaloids, which are not destroyed during cooking.

The most commonly used anti-germinating treatment processes make use of chemical agents such as chloropropham, also known as chlorpropham, CIPC or 3-chlorophenylisopropylcarbamate. In general, CIPC is applied to stored tubers by fogging techniques. Generally, fogging applies CIPC by means of a hot air current so as to produce an aerosol.

In a first procedure, fogging is carried out using pure CIPC. However, this technique involves applying the active ingredient to the tubers in a pure form, in an unsatisfactory manner. Specifically, CIPC has a tendency to form clusters and/or is not distributed uniformly over the tubers.

In another procedure, the CIPC is formulated in a solvent medium. Thus, FR 2 563 974 discloses a composition for the treatment of fruit and vegetables by fogging, comprising in particular 2 to 20% by weight of a protective and/or preservative active ingredient, such as CIPC inter alia, and a glycol, for example propylene glycol. This technique does not produce satisfactory results, since the solvents used have low boiling points and have a tendency to evaporate rapidly during fogging. For example, the boiling point of propylene glycol is 187° C. However, the fogging temperature must be at least 30° C. below the boiling temperature of the solvent, to prevent evaporation of the solvent and the production of vapour instead of fog. However, if fogging is carried out at approximately 157° C., the fog obtained is not of a sufficient quality, since the size of the particles produced during fogging is too large: the bulbs or tubers are not covered homogeneously and the penetrating power of the product into the mass of the stored commodity is too low.

Moreover, EP 1 694 126 discloses concentrated solutions comprising 50 to 80% by weight of CIPC based on the total volume of the solution in one or more terpenes, such as eugenol and/or terpenic oils. A solution comprising 636 g/l of CIPC and comprising ethoxylated lauric alcohol, which is used as an emulsifying agent in the eugenol, was thus obtained. However, eugenol has an unpleasant aroma and is a product classed as an irritant, and this could make it difficult to develop and use.

There is thus a need to provide, on the one hand, more highly concentrated formulations of CIPC so as to reduce the amounts of solvents to be used and, on the other hand, formulations comprising a solvent having a higher boiling point to avoid the above-mentioned drawbacks.

It has now been found—and this is one subject-matter of the present invention—that dialkylene glycols, also referred to hereinafter as dialkene glycols, have a high solvent power towards CIPC. In particular, the use of dialkylene glycols makes it possible to obtain clear solutions of CIPC and to achieve particularly concentrated solutions of CIPC at ambient temperature, even temperatures as low as 0° C. As a result, the formulations of the present invention make it possible to reduce the amount of formulated product and thus the amount of solvent to be used, resulting in reduced costs and improved safety and speed of application.

A first aspect of the invention relates to a solution of CIPC in a dialkylene glycol.

“Dialkylene glycol” denotes a compound of the following formula (I):

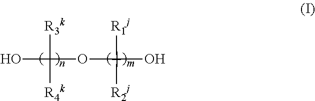

in which:
n and m independently represent an integer from 1 to 5,
j represents an integer varying from 1 to m and k represents an integer varying from 1 to n,
for each value of j and for each value of k, R₁^{j}, R₂^{j},R₃^{k} and R₄^{k} are the same or different and independently represent a hydrogen atom, a linear or branched hydrocarbon comprising 1 to 10 carbon atoms, in particular a linear or branched alkyl group comprising 1 to 10 carbon atoms, preferably 1 to 5 carbon atoms. Preferably, for each value of j and for each value of k, R₁^{j}, R₂^{j}, R₃^{k} and R₄^{k} independently represent a hydrogen atom, a methyl, an ethyl, an n-propyl or i-propyl group.

Diethylene glycol, dipropylene glycol and dibutylene glycol are examples of dialkylene glycol. In one particular aspect, said dialkylene glycol is dipropylene glycol.

The solution may comprise a mixture of dialkylene glycols of formula (I).

“Solution” is taken to mean that CIPC is soluble in dialkylene glycol. Thus, when the formulation according to the invention is applied to the bulbs or tubers, the CIPC is distributed uniformly and does not lead to the formation of clusters.

The above-mentioned solution comprises 350 to 900 g/l of CIPC, in particular 550 to 850 g/l, preferably 600 to 700 g/l.

CIPC is advantageously highly soluble in dialkylene glycols. The proposed solution thus makes it possible to reduce the amounts of solvents to be used in comparison with known formulations. The solvents are harmful because of their inherent toxicity and/or the risks they present during use, in particular due to significant flammability risks. It is therefore advantageous to reduce the amounts of solvents used. Moreover, the use of concentrated solutions of CIPC makes it possible to increase the speed of the application of the formulation to the bulbs or tubers, since a smaller amount of solution is required to reach the effective dose of CIPC.

Moreover, the solutions according to the invention are completely stable for a plurality of months, preferably at least one month, at a low temperature, preferably up to 0° C. This makes it possible for users to store the CIPC formulations in cold chambers.

In one embodiment, the solution may further comprise one or more emulsifying agents.

According to the present invention, an “emulsifying agent” means any type of agent conventionally used for this purpose, such as ethoxylated fatty alcohols, ethoxylated fatty acids, ethoxylated alkylphenols or any other non-ionic product.

The solutions generally comprise 0 to 20% by weight, in particular 0 to 15% by weight, preferably 1 to 5% by weight of emulsifying agent.

The solution may further comprise surfactants which are known per se.

Preferably, the solution is free of terpenes, such as eugenol and/or terpenic oils.

A second aspect of the invention also relates to a method for the treatment of bulbs or tubers, in particular potatoes, using the above-mentioned solution. The method is preferably used for anti-germinating treatment.

The solution according to the invention can be applied to tubers and bulbs using any one of the methods known from the art, in particular by spraying or fogging. Preferably, the solution is applied by fogging. This technique is known per se. It may advantageously be carried out using the Xeda Electrofog or any other device of the type disclosed in application FR 2 566 681.

Dialkylene glycols have high boiling points. It is thus possible to carry out fogging at high temperatures and to obtain high-quality fogs. For example, the boiling point of dipropylene glycol is 232° C. The appropriate temperature for logging is approximately 30° C. below the boiling point, and is therefore approximately 192° C. At this temperature, a high-quality fog is obtained (i.e. a fog composed of small, thinly distributed particles), and this makes it possible to distribute the CIPC over the bulbs or tubers in a highly homogeneous manner.

Preferably, the solution is applied at a temperature of between 170 and 230° C., in particular between 190 and 215° C.

The amount of the solution according to the invention to be applied to the tubers and bulbs basically depends on the selected method of application. In general, 20 to 30 g, preferably 25 to 28 g of CIPC in total are applied per tonne of bulbs or tubers treated, over a period of 6 months. More generally, the amount of active ingredient applied is adjusted as a function of the storage time.

Application may be continuous or intermittent over the storage time. Preferably, application is repeated approximately every two months in the storage chamber.

A third aspect of the invention further relates to a process for preparing solutions of CIPC, comprising the step of solubilising CIPC in a dialkylene glycol. The dialkylene glycol is preferably dipropylene glycol. The solubilisation may be carried out while stirring.

A fourth aspect of the invention relates to the use of dipropylene glycol to solubilise CIPC.

The following are given as non-limiting illustrative examples of the present invention.

### EXAMPLE 1

63.3 g of CIPC (sold by LUXAN Holland), 2.9 g of lauric alcohol ethoxylated at 11 moles (emulsifying agent) and 44.8 g of dipropylene glycol are mixed at room temperature whilst stirring to produce 100 ml of a completely clear and stable solution. This operation is repeated with amounts of CIPC varying from 50 to 110 g in the same amount of dipropylene glycol and optionally emulsifying agent in an amount of 5%. For 50 g of CIPC, 45 g of dipropylene glycol and 5 g of lauric alcohol ethoxylated at 11 moles, a 550 g/l solution of CIPC is obtained. For 110 g of CIPC, 46 g of dipropylene glycol and 3 g of lauric alcohol ethoxylated at 11 moles, a 780 g/l solution of CIPC is obtained. The same clarity and stability are obtained.

By way of comparison, a solution of CIPC in propylene glycol has a solubility limit of 58% CIPC (in weight per volume of solution).

### EXAMPLE 2

The solutions from Example 1 are applied to potatoes in cold chambers using the Xeda Electrofog at a temperature of 210° C., 15 to 20 days after the potatoes are put into storage, with an initial dose of 12 ppm CIPC then with a dose of 8 ppm CIPC every 6 to 8 weeks.

1. A solution of CIPC in a dialkylene glycol.

2. The solution according to claim 1, in which the dialkylene glycol is dipropylene glycol.

3. The solution according to claim 1, comprising 350 to 900 g/l of CIPC.

4. The solution according to claim 3, comprising 550 to 850 g/l of CIPC.

5. The solution according to claim 1, comprising one or more emulsifying agents.

6. The solution according to claim 1, comprising 0 to 20% by weight of emulsifying agent.

7. A method for the treatment of bulbs or tubers, using the solution according to claim 1.

8. The method according to claim 7, for the anti-germinating treatment of potatoes.

9. The method according to claim 7, in which said solution is applied by fogging.

10. The method according to claim 7, in which the solution is applied at a temperature of between 170 and 230° C.

11. The method according to claim 10, in which the solution is applied at a temperature of between 190 and 215° C.

12. A process for the preparation of solutions of chloropropham (CIPC), comprising the step of solubilising CIPC in a dialkylene glycol.

13. The process according to claim 12, in which the dialkylene glycol is dipropylene glycol.
